(19) United States
(12) Patent Application Publication
(10) Pub. No.: US 2024/0054397 A1
(43) Pub. Date: Feb. 15, 2024

(54) PROCESSING SYSTEM, LEARNING PROCESSING SYSTEM, PROCESSING METHOD, AND PROGRAM

(71) Applicant: Panasonic Intellectual Property Management Co., Ltd., Osaka (JP)

(72) Inventors: Jeffry NAINGGOLAN, Osaka (JP); Yuya SUGASAWA, Osaka (JP); Hisaji MURATA, Osaka (JP); Yoshinori SATOU, Osaka (JP); Hisashi AIKAWA, Osaka (JP)

(21) Appl. No.: 18/255,034

(22) PCT Filed: Oct. 14, 2021
(86) PCT No.: PCT/JP2021/038140

§ 371 Date: May 30, 2023

(30) Foreign Application Priority Data
Dec. 7, 2020 (JP) 2020-202864

(51) Int. Cl. G06N 20/00

(52) U.S. Cl. CPC G06N 20/00

(57) ABSTRACT

A processing system includes a first acquirer, a second acquirer, a third acquirer, an identifier, and an extractor. The first acquirer is configured to acquire a plurality of pieces of learning data to which labels have been assigned. The second acquirer is configured to acquire a learned model generated based on the plurality of pieces of learning data. The third acquirer is configured to acquire identification data to which a label has been assigned. The identifier is configured to identify the identification data on a basis of the learned model. The extractor is configured to extract, based on an index which is applied in the learned model and which relates to similarity between the identification data and each of the plurality of pieces of learning data, one or more pieces of learning data similar to the identification data from the plurality of pieces of learning data.

### TECHNICAL FIELD

The present disclosure generally relates to processing systems, learning processing systems, processing methods, and programs. More specifically, the present disclosure relates to a processing system relating to data to which a label has been assigned, a learning processing system including the processing system, a processing method, and a program.

### BACKGROUND ART

Patent Literature 1 discloses a data analyzer. The data analyzer repeats, a predetermined number of times, a series of processes including: dividing labeled training data into model building data and model verifying data; building a machine learning model by using the model building data; and applying the machine learning model to the model verifying data to identify samples. The data analyzer obtains the number of times of incorrect identification that a label which is a result of identification by the data analyzer and a label initially assigned to the data are inconsistent with each other for each sample, and the data analyzer determines, based on the number of times of the incorrect identification or the probability of the incorrect identification, whether or not the sample is mislabeled. This enables a sample(s) which is included in the training data and which is highly possibly mislabeled to be detected with high accuracy.

The data analyzer of Patent Literature 1 has to repeat the series of processes a predetermined number of times and may thus take a long time to identify mislabeling (a wrong label).

### CITATION LIST

### Patent Literature

Patent Literature 1: JP 2018-155522 A

### SUMMARY OF INVENTION

In view of the foregoing background, it is an object of the present disclosure to provide a processing system, a learning processing system, a processing method, and a program which are configured to reduce time required to identify a wrong label.

A processing system of an aspect of the present disclosure includes a first acquirer, a second acquirer, a third acquirer, an identifier, and an extractor. The first acquirer is configured to acquire a plurality of pieces of learning data to which labels have been assigned. The second acquirer is configured to acquire a learned model generated based on the plurality of pieces of learning data. The third acquirer is configured to acquire identification data to which a label has been assigned. The identifier is configured to identify the identification data on a basis of the learned model. The extractor is configured to extract, based on an index which is applied in the learned model and which relates to similarity between the identification data and each of the plurality of pieces of learning data, one or more pieces of learning data similar to the identification data from the plurality of pieces of learning data.

A learning processing system of an aspect of the present disclosure includes the processing system and a learning system configured to generate the learned model.

A processing method of an aspect of the present disclosure includes a first acquisition step, a second acquisition step, a third acquisition step, an identification step, and an extraction step. The first acquisition step includes acquiring a plurality of pieces of learning data to which labels have been assigned. The second acquisition step includes acquiring a learned model generated based on the plurality of pieces of learning data. The third acquisition step includes acquiring identification data to which a label has been assigned. The identification step includes identifying the identification data on a basis of the learned model. The extraction step includes extracting, based on an index which is applied in the learned model and which relates to similarity between the identification data and each of the plurality of pieces of learning data, one or more pieces of learning data similar to the identification data from the plurality of pieces of learning data.

A program of an aspect of the present disclosure is a program configured to cause one or more processors to execute the processing method.

### BRIEF DESCRIPTION OF DRAWINGS

FIG. 1 is a schematic block diagram of the entirety of a learning processing system including a processing system according to an embodiment;

FIGS. 2A and 2B are illustrative view of a first operation example and a second operation example of the processing system;

FIG. 3 is a flowchart illustrating operation of the learning processing system;

FIG. 4 is an illustrative view of a third operation example of the processing system;

FIG. 5 is an illustrative view of a fourth operation example of the processing system; and

FIG. 6 is an illustrative view of a fifth operation example of the processing system.

### DESCRIPTION OF EMBODIMENTS

(1) Overview

The drawings to be referred to in the following description of embodiments are all schematic representations. Thus, the ratio of the dimensions (including thicknesses) of respective constituent elements illustrated on the drawings does not always reflect their actual dimensional ratio.

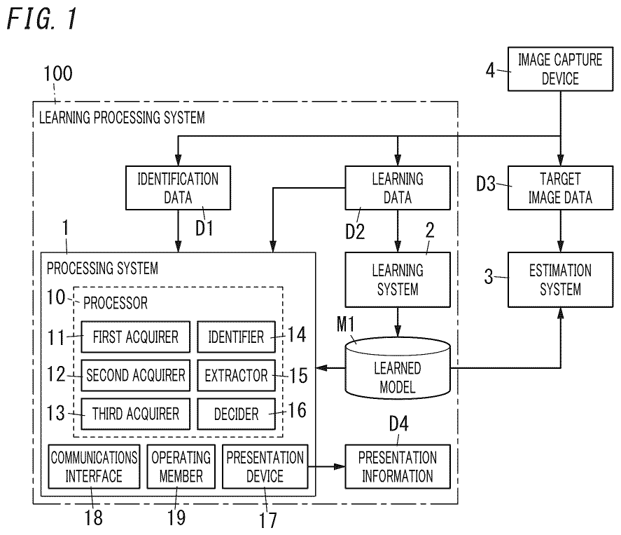

As shown in FIG. 1, a processing system 1 according to the present embodiment includes a first acquirer 11, a second acquirer 12, a third acquirer 13, an identifier 14, and an extractor 15.

The first acquirer 11 acquires a plurality of pieces of learning data D2 to which labels have been assigned. The second acquirer 12 acquires a learned model M1 generated based on the plurality of pieces of learning data D2.

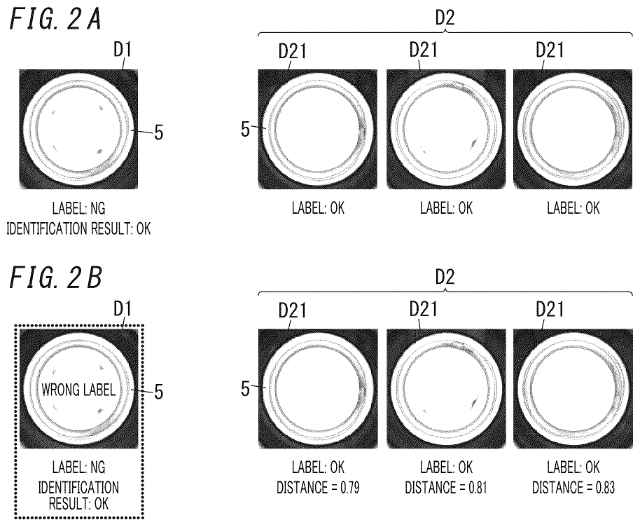

As used herein, the learning data D2 is, for example, image data. The learning data D2 is image data captured with, for example, an image capture device 4 (see FIG. 1). However, the image data may be processed data such as computer graphics. Moreover, the image data is supposed to be a still image but may be a moving image or data of a frame of an image fed frame by frame. The learning data D2 is data for generating the learned model M1 about an object 5 (see FIGS. 2A and 2B: object) shot in the image data. That is, the learning data D2 is learning data for use to generate a model by machine learning. As used in the present disclosure, the “model” refers to a program designed to estimate, in response to input of input data about an identification target (object 5), the condition of the identification target and output a result of the estimation (result of identification). Also, as used herein, the “learned model” refers to a model about which machine learning using learning data is completed. Moreover, “learning data (set)” refers to a data set including, in combination, input data (image data) to be entered for a model and a label assigned to the input data, i.e., so-called “training data”. That is to say, in this embodiment, the learned model M1 is a model about which machine learning has been done by supervised learning.

Note that in the present disclosure, “object 5 shot in image data” includes the meaning of “an object 5 captured in an image represented by image data”.

In the present embodiment, the learned model M1 is, for example, a model generated by deep learning on the plurality of pieces of learning data D2.

In the present embodiment, the object 5, which is the identification target, is, for example, a battery as shown in FIGS. 2A and 2B. That is, the learning data D2 is an image (image data) of the battery. Thus, the learned model M1 estimates the exterior appearance of the battery and outputs a result of the estimation. Specifically, the learned model M1 outputs, as the result of the estimation, whether the exterior appearance of the battery is good (OK) or defective (NG). In other words, the learned model M1 is used to conduct an appearance test of the battery. In the following, the types of a label to be assigned to each of the plurality of pieces of learning data D2 are supposed to be only two, “OK” or “NG” to facilitate the description. However, the types of the “label” as mentioned in the present disclosure is not limited to the two types, “OK” and “NG”. For example, for “NG”, a label showing more detailed information (e.g., types of the defect) may be given.

When the contents described above are expressed in other words, the processing system 1 estimates the exterior appearance of the battery on the basis of the learned model M1 and outputs the result of the estimation. Specifically, the processing system 1 uses the learned model M1 and outputs, as a result of estimation, whether the exterior appearance of the battery is good (OK) or defective (NG).

The third acquirer 13 of the present embodiment acquires identification data D1 to which a label has been assigned. In the present embodiment, the identification data D1 is, similarly to the learning data D2, for example, image data, and the object 5 shot in the image data is a battery. The identification data D1 is, for example, training data newly obtained for re-learning for updating the learned model M1 about which the machine learning is completed. More specifically, the identification data D1 is data which will be learning data to be newly added besides currently available learning data or will be learning data used to update the currently available learning data. The identification data D1 may be assigned “OK” or “NG” similarly to the plurality of pieces of learning data D2.

Incidentally, generating a model by machine learning requires work (labeling) of assigning labels to the training data (identification data D1 and learning data D2) by a person. However, when labels are assigned by a person, simple work mistakes may occur, or the standard of labeling may become vague depending on people. As a result, the labeled training data may include data which is assigned an inappropriate label (wrong label). A wrong label may be present in identification data D1 which is newly obtained as well as in the learning data D2 used for generation of the learned model M1.

In the present disclosure, the wrong label refers to a label which is assigned to data and which is inappropriate. Examples of the wrong label include an NG label actually assigned to data which should be assigned an OK label and an OK label actually assigned to data which should be assigned an NG label.

In the processing system 1 of the present embodiment, the identifier 14 identifies the identification data D1 on the basis of the learned model Ml. The extractor 15 extracts, based on an index which is applied in the learned model M1 and which relates to similarity between the identification data D1 and each of the plurality of pieces of learning data D2, one or more pieces of learning data D2 similar to the identification data D1 from the plurality of pieces of learning data D2. As used herein, the “index which is applied in the learned model M1 and which relates to similarity” is, for example, an index in a fully connected layer directly before an output layer in the deep learning and is a Euclidean distance in the present embodiment. That is, a “distance” is obtained from a feature amount such as a pixel value obtained from two images which are compared, and the closeness of the two images is estimated. The “distance” which is an index of similarity is inversely proportional to the similarity. The “distance” which is an index of similarity may be Mahalanobis' generalized distance, Manhattan distance, Chebyshev distance, or Minkowski distance besides the Euclidean distance. Further, the index is not limited to the distance but may be similarity, (correlation) coefficient, or the like, and may be, for example, the similarity of n-dimension vectors, cosine similarity, a Pearson correlation coefficient, deviation pattern similarity, a Jaccard index, a Dice coefficient, or a Simpson's Coefficient.

In sum, one or more pieces of similar learning data D2 are extracted based on the index of similarity used when the learned model M1 classifies input data (identification data D1). The extractor 15 extracts a plurality of (e.g., the top three) pieces of learning data D2 having the higher similarity to the identification data D1.

The one or more pieces of similar learning data D2 are extracted as described above, and therefore, checking the one or more pieces of learning data D2 similar to the identification data D1 at least once enables the presence or absence of a wrong label to be identified. Consequently, time required to identify a wrong label can be reduced.

Moreover, a learning processing system 100 according to the present embodiment includes the processing system 1 and a learning system 2 configured to generate the learned model M1 as shown in FIG. 1. This can provide a learning processing system 100 configured to reduce time required to identify a wrong label.

Further, a processing method according to the present embodiment includes a first acquisition step, a second acquisition step, a third acquisition step, an identification step, and extraction step. The first acquisition step includes acquiring the plurality of pieces of learning data D2 to which labels have been assigned. The second acquisition step includes acquiring the learned model M1 generated based on the plurality of pieces of learning data D2. The third acquisition step includes acquiring the identification data D1 to which a label has been assigned. The identification step identifies the identification data D1 on the basis of the learned model M1. The extraction step includes extracting, based on the index which is applied in the learned model M1 and which relates to the similarity between the identification data D1 and each of the plurality of pieces of learning data D2, one or more pieces of learning data D2 similar to the identification data D1 from the plurality of pieces of learning data D2. This configuration provides a processing method configured to reduce time required to identify a wrong label. This processing method is used on a computer system (processing system 1). That is, this processing method may be implemented as a program. A program according to the present embodiment is a program configured to cause one or more processors to execute the processing method according to the present embodiment.

(2) Details

An entire system including the learning processing system 100 including the processing system 1 according to the present embodiment and peripheral components of the learning processing system 100 will be described in detail below with reference to FIG. 1. Note that at least some of the peripheral components may be included in components constituting the learning processing system 100.

(2.1) Overall Structure

The learning processing system 100 includes the processing system 1 and the learning system 2 as shown in FIG. 1. Moreover, the peripheral components of the learning processing system 100 include an estimation system 3 and one or a plurality of image capture devices 4 (only one image capture device is shown in FIG. 1).

The processing system 1, the learning system 2, and the estimation system 3 are supposed to be implemented as, for example, a server. The “server” as used herein is supposed to be implemented as a single server device. That is to say, major functions of the processing system 1, the learning system 2, and the estimation system 3 are supposed to be provided for a single server device.

Alternatively, the “server” may also be implemented as a plurality of server devices. Specifically, the functions of the processing system 1, the learning system 2, and the estimation system 3 may be provided for three different server devices, respectively. Alternatively, two out of these three systems may be provided for a single server device. Optionally, those server devices may form a cloud computing system.

Furthermore, the server device may be installed either inside a factory where an appearance test is conducted on batteries or outside the factory (e.g., at a service headquarters), whichever is appropriate. If the respective functions of the processing system 1, the learning system 2, and the estimation system 3 are provided for three different server devices, then each of these server devices is preferably connected to the other server devices to be ready to communicate with the other server devices.

The learning system 2 is configured to generate the learned model M1 about the object 5. The learning system 2 generates the learned model M1 based on a plurality of pieces of labeled learning data D2 (image data). The learned model M1 as used herein may include, for example, either a model that uses a neural network or a model generated by deep learning using a multilayer neural network. Examples of the neural networks may include a convolutional neural network (CNN) and a Bayesian neural network (BNN). The learned model M1 may be implemented by, for example, installing a learned neural network into an integrated circuit such as an application specific integrated circuit (ASIC) or a field-programmable gate array (FPGA). However, the learned model M1 does not have to be a model generated by deep learning. Alternatively, the learned model M1 may also be a model generated by a support vector machine or a decision tree, for example.

Each of the plurality of pieces of learning data D2 is generated by assigning a label indicating either “OK (good product)” or “NG (defective product)” to a corresponding one of the image data. The work of assigning the label (labeling) is performed on the learning processing system 100 by a user via a user interface such as an operating member 19. The learning system 2 generates, based on the plurality of pieces of labeled learning data D2, the learned model M1 through machine learning on good products and defective products of batteries.

Optionally, the learning system 2 may attempt to improve the performance of the learned model M1 by making re-learning using newly acquired labeled learning data as identification data D1. For example, if a new type of defect is found in the object 5, then the learning system 2 may be made to do re-learning about the new type of defect.

The learned model M1 generated by the learning system 2 is stored (recorded) in a storage. The storage which stores the learned model M1 includes rewritable nonvolatile memory such as Electrically Erasable Programmable Read-Only Memory (EEPROM).

The processing system 1 has a function of executing the extraction process of extracting the learning data D2 similar to the identification data D1 to facilitate the determination of whether or not a wrong label is present in the training data (identification data D1 and learning data D2). In the following description, a person who uses the learning processing system 100 including the processing system 1 will be hereinafter simply referred to as a “user”. The user may be, for example, an operator who monitors a manufacturing process of a battery (object 5) in a factory or a chief administrator.

The processing system 1 includes a processor 10, a presentation device 17, a communications interface 18, and the operating member 19 as shown in FIG. 1. The processing system 1 further includes a storage.

Optionally, some functions of the processing system 1 may be distributed in a telecommunications device with the capability of communicating with the server. Examples of the “telecommunications devices” as used herein may include personal computers (including laptop computers and desktop computers) and mobile telecommunications devices such as smartphones and tablet computers. In this embodiment, the functions of the presentation device 17 and the operating member 19 are provided for the telecommunications device to be used by the user. A dedicated application software program allowing the telecommunications device to communicate with the server is installed in advance in the telecommunications device.

The processor 10 may be implemented as a computer system including one or more processors (microprocessors) and one or more memories. That is to say, the one or more processors may perform the functions of the processor 10 by executing a program (application) stored in the one or more memories. In this embodiment, the program is stored in advance in the memory of the processor 10. Alternatively, the program may also be downloaded via a telecommunications network such as the Internet or distributed after having been stored in a non-transitory storage medium such as a memory card.

The processor 10 performs the processing of controlling the presentation device 17, the communications interface 18, the operating member 19, and the like. The functions of the processor 10 are supposed to be performed by the server. Further, the processor 10 has functions of executing an identification process, the extraction process, and a decision process, and as shown in FIG. 1, the processor 10 includes the first acquirer 11, the second acquirer 12, the third acquirer 13, the identifier 14, the extractor 15, and a decider 16. Details of the first acquirer 11, the second acquirer 12, the third acquirer 13, the identifier 14, the extractor 15, and the decider 16 will be described in the next section.

The presentation device 17 may be implemented as either a liquid crystal display or an organic electroluminescent (EL) display. The presentation device 17 is provided for the telecommunications device as described above. Optionally, the presentation device 17 may also be a touchscreen panel display. The presentation device 17 presents, to an external device, information (presentation information D4) about a decision made by the decider 16 (to be described later). In addition, the presentation device 17 may also display various types of information (such as the result of estimation made by the estimation system 3), besides the presentation information D4.

The communications interface 18 is a communications interface for communicating with one or more image capture devices 4 either directly or indirectly via, for example, the user's telecommunications device or another server having the function of a production management system. In this embodiment, the function of the communications interface 18, as well as the function of the processor 10, is supposed to be provided for a single server. However, this is only an example and should not be construed as limiting. Alternatively, the function of the communications interface 18 may also be provided for the telecommunications device, for example. The communications interface 18 receives, from the image capture device 4 or the additional server, the identification data D1 and the learning data D2.

Each of the identification data D1 and the learning data D2 is data which is image data captured with the image capture device 4 and which is assigned a label (here, “OK” or “NG”), and the image data includes a pixel region representing the object 5. Moreover, the object 5 is a battery as described above, and each of the identification data D1 and the learning data D2 is data including a pixel region representing the exterior appearance of the battery. The image capture device 4 includes, for example, a line sensor camera.

The image data applicable as training data (learning data D2) is chosen in accordance with, for example, the user's command from a great many pieces of image data about the object 5 shot with the image capture device 4. The learning processing system 100 is provided with the function of supporting the work of sorting the image data and labeling the image data. The learning processing system 100 may include a user interface (which may be the operating member 19) that accepts the user's command about sorting and labeling.

Examples of the operating member 19 include a mouse, a keyboard, and a pointing device. The operating member 19 is provided for the telecommunications device to be used by the user as described above. If the presentation device 17 is a touchscreen panel display of the telecommunications device, then the presentation device 17 may also have the function of the operating member 19.

The estimation system 3 makes, based on the learned model M1 generated by the learning system 2, an estimation on target image data D3 to be input (estimation phase). The estimation system 3 is configured to communicate directly, or indirectly over a telecommunications device of the user, another server having a function as the production management system, or the like, with the one or plurality of image capture devices 4. The estimation system 3 receives the target image data D3 obtained by capturing, with the one or a plurality of image capture devices 4, an image of a battery (product or semi-product) having actually undergone the production process. The estimation system 3 then executes the appearance test on the battery.

The estimation system 3 determines, based on the learned model M1, whether the object 5 shot in the target image data D3 is a good product or a defective product. The estimation system 3 outputs the result of identification (i.e., the result of estimation) about the target image data D3 to, for example, the telecommunications device used by the user or the production management system. This allows the user to check the result of estimation through the telecommunications device. Optionally, the production management system may control the production facility to discard a battery that has been determined, based on the result of estimation acquired by the production management system, to be a defective product before the battery is transported and subjected to the next processing step.

The function, which will be described later, of the identifier 14 of the processing system 1 is substantially equivalent to the function of the estimation system 3.

(2.2) Wrong Label Detection

The processor 10 has a function of executing the identification process, the extraction process, and the decision process to detect a wrong label. Specifically, the processor 10 includes the first acquirer 11, the second acquirer 12, the third acquirer 13, the identifier 14, the extractor 15, and the decider 16 as shown in FIG. 1.

The first acquirer 11 is configured to acquire a plurality of pieces of labeled learning data D2. The first acquirer 11 acquires, in response to an operation input given by a user via the operating member 19, all the plurality of pieces of labeled learning data D2 used to generate the learned model M1, for example, from a storage storing the plurality of pieces of labeled learning data D2. The presentation device 17 is configured to display the labeled learning data D2 acquired by the first acquirer 11 on a screen such that the user can view the labeled learning data D2.

The second acquirer 12 is configured to acquire the learned model M1 generated based on the plurality of pieces of learning data D2 by the learning system 2. The second acquirer 12 acquires, in response to an operation input given by the user via the operating member 19, the learned model M1, for example, from a storage storing the learned model Ml.

The third acquirer 13 is configured to acquire labeled identification data D1. The third acquirer 13 acquires, in response to an operation input given by the user via the operating member 19, newly prepared labeled identification data D1, for example, from a storage storing the newly prepared labeled identification data D1. The presentation device 17 is configured to display the labeled identification data D1 acquired by the third acquirer 13 on the screen such that the user can view the labeled identification data D1.

The identifier 14 is configured to identify the identification data D1 on the basis of the learned model M1 (identification process). The identifier 14 causes whether the object 5 (battery) shot in the identification data D1 is OK or NG to be identified based on the learned model M1 acquired by the second acquirer 12. That is, the identifier 14 makes the learned model M1 classify (identify) whether the identification data D1 is OK or NG, just like the target image data D3 (input data) in the estimation system 3. As described later, the result by the identification process is compared with a label actually given to the identification data D1.

The extractor 15 is configured to extract, based on the index which is applied in the learned model M1 and which relates to the similarity between the identification data D1 and each of the plurality of pieces of learning data D2, one or more pieces of learning data D2 similar to the identification data D1 from the plurality of pieces of learning data D2 (extraction process). In the following description, each of the one or more pieces of learning data D2 thus extracted may be referred to as “similar data D21”. Here, the extractor 15 extracts, based on information on a fully connected layer directly before the output layer in the deep learning, the similar data D21 (learning data D2). The extractor 15 obtains the index of similarity (e.g., Euclidean distance) between a feature amount relating to a pixel value or the like obtained from an image of the identification data D1 and a feature amount relating to a pixel value or the like obtained from an image of each piece of learning data D2, thereby estimating closeness between the images. In the following description, the index of similarity may simply be referred to as a “distance”. The extractor 15 obtains the index to estimate the similarity between the identification data D1 and each piece of learning data D2.

A shorter distance from the similar data D21 to the identification data D1 means that the similar data D21 is an image closer to the identification data D1. In other words, the learned model M1 compares, in the fully connected layer, the distance between a feature amount obtained from the input data and a feature amount obtained from each piece of learning data D2. That is, the extractor 15 compares, by using the learned model Ml, the distance between the feature amount obtained from the input data and the feature amount obtained from each piece of learning data D2 in the fully connected layer of the learned model M1. As a result, the input data is classified, based on the label of one of the pieces of learning data D2 which has a short distance to the input data, into a result as a highly possibly good product (OK), or a result as a highly possibly defective product (NG), by the learned model M1, and the classification result is output from the output layer of the learned model Ml.

Thus, the extractor 15 extracts, based on the distance between the identification data D1 and each piece of learning data D2, the similar data D21 highly similar to the identification data D1 from the plurality of pieces of learning data D2. For example, the extractor 15 extracts, as the similar data D21, learning data D2 having a distance shorter than or equal to a predetermined threshold. Alternatively, the extractor 15 may extract, as the similar data D21, the top N pieces of learning data D2 having the higher similarity (having the shorter distance) from the plurality of pieces of learning data D2 (N is a natural number). The predetermined threshold and/or N (the number of pieces) may be arbitrarily set by the user. In the present embodiment, the processing system 1 is configured to receive setting information on the predetermined threshold and/or N (the number of pieces) from the user via the operating member 19. The setting information is stored in a memory of the processor 10 or the like. In the following description, the top three pieces of similar data D21 having the shorter distance to the identification data D1 are supposed to be extracted.

The decider 16 is configured to make a decision as to the presence or absence of a wrong label on the basis of the identification data D1 and the one or more pieces of learning data D2, (decision process). In the present embodiment, the processor 10 causes the decider 16 to execute the decision process when a specific condition is satisfied. The specific condition is that the result of identification by the identification process is inconsistent with the label of the identification data D1. In other words, the decider 16 makes the decision as to the presence or absence of a wrong label when the result of identification of the identification data D1 by the identifier 14 is inconsistent with the label assigned to the identification data D1. Thus, the decision process is executed only when the specific condition is satisfied, which reduces the possibility that the decision process is unnecessarily executed, thereby contributing to a reduction in processing load. Consequently, time required to specify mislabeled data can also be reduced. Here, the extraction process described above is also executed when the specific condition is satisfied, and therefore, the processing load is further reduced.

In sum, the decider 16 makes the decision as to the presence or absence of a wrong label on the basis of the identification data D1 and the one or more pieces of similar data D21 (learning data D2) for a label assigned to the identification data D1 and one or more labels respectively assigned to the one or more pieces of similar data D21. Note that as used in the present disclosure, the “label of the identification data D1” refers to a label assigned to the identification data D1, and the “label of the learning data D2” refers to a label assigned to the learning data D2.

Note that the decider 16 forgoes making the decision as to the presence or absence of a wrong label when the result of identification of the identification data D1 by the identifier 14 is consistent with the label assigned to the identification data D1.

Moreover, in the present embodiment, the decider 16 makes the decision as to the presence or absence of a wrong label on the basis of at least one of: the label of the identification data D1 and the one or more labels respectively of the one or more pieces of similar data D21 (learning data D2); or the index relating to the similarity of each of the one or more pieces of similar data D21 (learning data D2) to the identification data D1. In the next section “(2.3) Operation”, a case where the decision as to the presence or absence of a wrong label is made based on the “labels” will be described in a first operation example, and a case where the decision as to the presence or absence of a wrong label is made based on both the “labels” and the “index of similarity” will be described in a second operation example Each of the first and second operation examples is an example in which a wrong label is present in the identification data D1. Moreover, in the present embodiment, the decider 16 further has a function of identifying that the learning data D2 has a wrong label, which will be described in a third operation example in the next section “(2.3) Operation”.

In sum, the decider 16 makes the decision as to the presence or absence of a wrong label on the basis of at least one of: the label assigned to the identification data D1 and the one or more labels respectively assigned to the one or more pieces of similar data D21 (learning data D2); or the index relating to the similarity between the identification data D1 and each of the one or more pieces of similar data D21 (learning data D2).

The storage of the processing system 1 stores various types of information. More specifically, the storage stores the plurality of pieces of learning data D2 acquired by the first acquirer 11, the learned model M1 acquired by the second acquirer 12, and the identification data D1 acquired by the third acquirer 13. The storage further stores the one or more pieces of similar data D21 extracted by the extractor 15. The storage further stores the decision made by the decider 16.

(2.3) Operation

Operation relating to the processing system 1 will be described in first to fifth operation examples below. The procedure of operation in each operation example is only an example and should not be construed as limiting.

<First Operation Example: Identification Data Having Wrong Label>

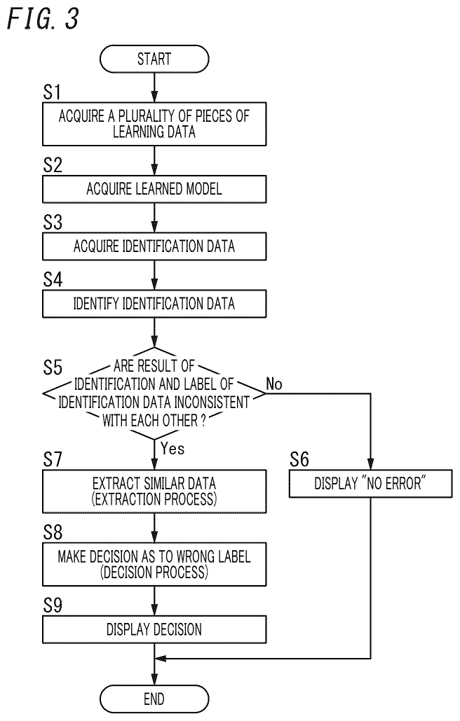

The first operation example will be described below with reference to FIGS. 2A, 2B, and 3.

The processor 10 of the processing system 1 acquires a plurality of pieces of labeled learning data D2, a learned model Ml, and labeled identification data D1 respectively by using the first acquirer 11, the second acquirer 12, and the third acquirer 13 (FIGS. 3: S1 to S3, first to third acquisition steps). The acquisition order of these pieces of data is not particularly limited. In the present operation example (first operation example), the identification data D1 is supposed to have been assigned a label “NG” (see FIG. 2A).

The processor 10 then identifies the identification data D1 on the basis of the learned model M1 by using the identifier 14 (FIG. 3: S4, identification step). Here, a result of the identification is supposed to be “OK” (see FIG. 2A). The processor 10 compares the result of the identification and the label of the identification data D1 with each other, and if they are inconsistent with each other (FIG. 3: Yes in S5), the process proceeds to the extraction process and the decision process. On the other hand, if the result of the identification and the label of the identification data D1 are consistent with each other (FIG. 3: No in S5), the processor 10 proceeds to nether the extraction process nor the decision process but causes the presentation device 17 to present a message saying, for example, “No error”, and the processor 10 ends the process. In the present operation example, the result of the identification is “OK” and the label is “NG”, and therefore, the process proceeds to the extraction process and the decision process.

The processor 10 extracts the similar data D21 from the plurality of pieces of learning data D2 by using the extractor 15 (FIG. 3: S7, extraction step). In this example, the top three pieces of similar data D21 having the shorter distance are extracted (see FIGS. 2A and 2B). Moreover, in this example, the distances of the three pieces of similar data D21 (distances of the pieces of similar data D21 from the identification data D1) are 0.79, 0.81, and 0.83 from the left, and the learned model M1 identifies that the similar data having a distance closer to 0 (zero) is an image closer to the identification data D1. Moreover, in this example, the labels of the three pieces of similar data D21 are all “OK”.

Then, the processor 10 makes, based on the identification data D1 and the three pieces of similar data D21, the decision as to the presence or absence of a wrong label by using the decider 16 (FIG. 3: S8). In the present disclosure, the decider 16 calculates a degree of mislabeling, and if the degree of mislabeling is high (e.g., higher than or equal to 90%), the decider 16 makes a decision that the identification data D1 is likely to have a wrong label. Specifically, in the present operation example, the decider 16 is configured to make the decision as to the presence or absence of a wrong label on the basis of an inconsistency ratio (degree of mislabeling) between the label of the identification data D1 and each of the one or more labels respectively of the one or more pieces of similar data D21 (learning data D2). In the example shown in FIG. 2A, the label of the identification data D1 is “NG”, whereas all the labels of the three pieces of similar data D21 are “OK”. The inconsistency ratio is thus 100%. Therefore, in the present operation example, the decider 16 makes a decision that the training data has a wrong label, and in particular, makes a decision that the identification data D1 is likely to have the wrong label. Note that a case where the inconsistency ratio is lower than 90% will be described later in the fifth operation example.

The processor 10 presents, by using the presentation device 17, presentation information D4 including the decision made by the decider 16 (FIG. 3: S9). In the present operation example, the identification data D1, for which the decision has been made that it is likely to have the wrong label, is presented in such a manner that character data “Wrong label” is superposed on an image of the identification data D1 and the image is surrounded by a frame as shown in FIG. 2B. That is, when the decision thus made is that a wrong label is present, the presentation device 17 presents information as to which of the identification data D1 and the one or more pieces of similar data D21 (learning data D2) has the wrong label. Here, three pieces of similar data D21 are also displayed for reference, as a set with the image of the identification data D1, on an identical screen of the presentation device 17 (see FIG. 2B). Moreover, information on the label and the result of the identification of the identification data D1 and information on the labels and information on the distance of each piece of similar data D21 are also shown together with the image. Thus, the user can easily understand that the “NG” label assigned to the identification data D1 is incorrect and a correct label should be “OK” by checking the information presented by the presentation device 17.

<Second Operation Example: Identification Data Having Wrong Label>

The second operation example will be described below with reference to FIG. 2B of the first operation example. The detailed description of operation substantially common with the first operation example described above may be omitted.

In the first operation example, in the decision process in S8 of FIG. 3, a decision as to the presence or absence of a wrong label is made based on the labels, that is, based on the inconsistency ratio of the labels as the degree of mislabeling. In the present operation example (second operation example), the decider 16 makes the decision as to the presence or absence of a wrong label on the basis of both of: the label of the identification data D1 and the one or more labels respectively of the one or more pieces of similar data D21 (learning data D2); and the index relating to the similarity of each of the one or more pieces of similar data D21 (learning data D2). That is, the decision method of the present operation example is different from the decision method described in the first operation example.

Specifically, the decider 16 calculates a degree of mislabeling F from the following equation (1), where F is the degree of mislabeling.

$$\begin{matrix}[ Formula 1 ] & \\ F = \frac{1}{N} {\sum }_{i = 0}^{N} {p}_{i} & Equation ( 1 )\end{matrix}$$

In the equation (1), N is the number of pieces of similar data D21 (here, N=3). Pi is supposed to be 0 (zero) when the label of similar data i and the label of the identification data D1 are consistent with each other, or Pi is calculated from the following equation (2) when the label of the similar data i and the label of the identification data D1 are inconsistent with each other. Here, K=0.001.

[Formula 2]

Pi=e^{-K×L}^{ᵢ} Equation(2)

In the equation (2), Pi is a value which approaches 1 as a distance i(Li) decreases. Pi in the equation (2) being a value close to 1 means that the similar data i and the identification data D1 are highly similar to each other in terms of their images although the labels thereof are inconsistent with each other. Therefore, as the degree of mislabeling F×100 (probability) approaches 100%, the decider 16 makes a decision that a wrong label is present, and in particular, that the identification data D1 is likely to have the wrong label.

In the example shown in FIG. 2B, the distances of the three pieces of similar data D21 are 0.79, 0.81, and 0.83 from the left, and all of these labels are inconsistent with the label of the identification data D1, and therefore, Pi of the similar data i is calculated from the equation (2). Each distance is actually substituted in the equation (2), thereby obtaining F×100, and in this case, the probability that the identification data D1 has the wrong label is {(0.99921+0.99919+0.99917)/3}×100≈99.9%.

The processing system 1 may be configured to choose a decision method based on the “ratio of label” of the first operation example or a decision method based on “both the labels and the index of similarity” of the present operation example in accordance with an operation input given to the operating member 19 or the like by the user.

Making the decision as to the presence or absence of a wrong label on the basis of both the label and the index of similarity as explained in the present operation example easily improves the reliability relating to a decision regarding the wrong label as compared with the first operation example in which the decision as to the presence or absence of a wrong label is made based on the inconsistency ratio. In particular, when the distances significantly vary between the pieces of similar data D21 thus extracted, the accuracy can be further improved as compared with the inconsistency ratio in the first operation example.

<Third Operation Example: Learning Data Having Wrong Label>

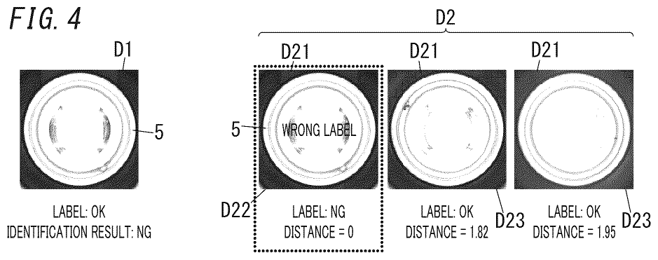

The third operation example will be described below with reference to FIGS. 3 and 4. The detailed description of operation substantially common with the first operation example described above may be omitted.

FIG. 2B referenced in connection with the description of the first and second operation examples shows an example in which the identification data D1 has a wrong label. In the present operation example (third operation example), an example in which the learning data D2 has a wrong label will be described.

The processor 10 of the processing system 1 acquires a plurality of pieces of labeled learning data D2, a learned model M1, and labeled identification data D1 (FIGS. 3: S1 to S3). In the present operation example, the identification data D1 is assigned a label “OK” (see FIG. 4).

The processor 10 then identifies the identification data D1 by using the learned model M1 (FIG. 3: S4). Here, a result of the identification is supposed to be “NG” (see FIG. 4). The processor 10 compares the result of the identification with the label of the identification data D1 (FIG. 3: S5). In the present operation example, the result of the identification is “NG” and the label is “OK”, and therefore, the process proceeds to the extraction process and the decision process.

The processor 10 extracts a plurality of similar data D21 from the plurality of pieces of learning data D2 (FIG. 3: S7). In this example, the distances of the three pieces of similar data D21 are 0 (zero), 1.82, and 1.95 from the left. Moreover, in this example, the labels of the three pieces of similar data D21 are “NG”, “OK”, and “OK” from the left.

The processor 10 then makes, based on the identification data D1 and the three pieces of similar data D21, the decision as to the presence or absence of a wrong label (FIG. 3: S8).

Here, the decider 16 of the present embodiment further has a function for identifying that the learning data D2 has a wrong label as described above. Specifically, the decider 16 identifies a piece(s) of particular learning data D22 similar to the identification data D1 to such an extent that the index relating to the similarity satisfies a predetermined condition from the one or more pieces of similar data D21 (learning data D2). When a label of the piece of particular learning data D22 is inconsistent with the label of the identification data D1 and a label of a piece of learning data D23 of the one or more pieces of similar data D21 except for the piece of particular learning data D22 is consistent with the label of the identification data D1, the decider 16 makes a decision that the piece of particular learning data D22 is more likely to have a wrong label than the identification data D1.

In the present embodiment, the index relating to the similarity is the “distance”, and therefore, the decider 16 identifies a piece of particular learning data D22 that satisfies a predetermined condition that “the distance is lower than or equal to the predetermined distance (threshold)”. Here, the predetermined distance (threshold) is supposed to be, for example, 0.001 but is not particularly limited to this example. When the index relating to the similarity is “similarity” such as the similarity of n-dimension vectors or cosine similarity, the decider 16 identifies a piece of particular learning data D22 that satisfies a predetermined condition that “the similarity is higher than or equal to prescribed similarity (threshold)”. The predetermined distance (threshold) and/or the prescribed similarity (threshold) may be arbitrarily set by the user. The processing system 1 is configured to receive setting information on the predetermined distance (threshold) and/or the prescribed similarity (threshold) via the operating member 19 from the user. The setting information is stored in a memory of the processor 10 or the like.

In the example shown in FIG. 4, the “distance” of a piece of similar data D21 at the left end of the three pieces of similar data D21 is shorter than or equal to a predetermined distance (0.001), and therefore, the decider 16 determines that the piece of similar data D21 at the left end corresponds to the piece of particular learning data D22 which is very similar to the identification data D1. The label (NG) of the piece of particular learning data D22 is inconsistent with the label (OK) of the identification data D1, and the labels (OK) of the two pieces of learning data D23 except for the piece of particular learning data D22 are consistent with the label (OK) of the identification data D1. The decider 16 thus makes a decision that the piece of particular learning data D22 is more likely to have a wrong label than the identification data D1.

Here, when the number of pieces of particular learning data D22 is ½ of the number of pieces of learning data D23, except for the pieces of particular learning data D22, which are consistent with the label of the identification data D1, the decider 16 makes a decision that the pieces of particular learning data D22 are likely to have a wrong label. In the example shown in FIG. 4, the number of pieces of particular learning data D22 is one, that is, ½ of the number of pieces of (two pieces of) learning data D23, and therefore, a decision that the piece of particular learning data D22 is likely to have a wrong label is made.

The processor 10 presents, by using the presentation device 17, presentation information D4 including the decision made by the decider 16 (FIG. 3: S9). In the present operation example, the piece of particular learning data D22, for which the decision has been made that it is likely to have the wrong label, is presented in such a manner that character data “Wrong label” is superposed on an image of the piece of particular learning data D22 and the image is surrounded by a frame as shown in FIG. 4. Moreover, information on the label and the result of the identification of the identification data D1 and information on the labels and information on the distance of each piece of similar data D21 are also shown together with the image. Thus, the user can easily understand that the “NG” label assigned to the piece of particular learning data D22 is incorrect and a correct label should be “OK” by checking the information presented by the presentation device 17.

The number of pieces of particular learning data D22 is greater than or equal to ½ of the number of pieces of learning data D23, the decider 16 makes a decision that a wrong label is absent. The processor 10 causes the presentation device 17 to present an image of the identification data D1 and images of the three pieces of similar data D21 together with a massage saying, for example, “Please check visually”. In other words, when the decision thus made is that no wrong label is present, the presentation device 17 presents both the identification data D1 and the one or more pieces of similar data D21 (learning data D2). That is, the processing system 1 prompts a user to have a check visually when automatically making a decision as to the presence or absence of a wrong label by the processing system 1 is difficult.

<Fourth Operation Example: Variation of Third Operation Example>

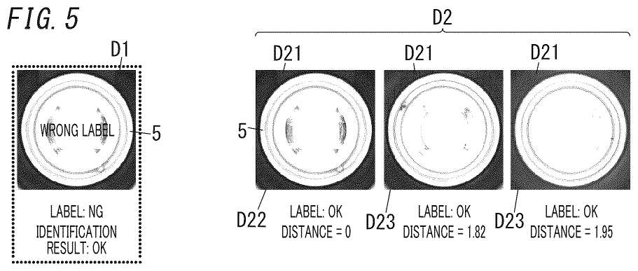

The fourth operation example will be described below with reference to FIG. 5. The detailed description of operation substantially common with the first operation example described above may be omitted.

The present operation example (fourth operation example) is a variation of the third operation example described above. The present operation example is similar to the third operation example in that a piece(s) of particular learning data D22 very similar to the identification data D1 is present. The present operation example is, however, different from the third operation example in that the identification data D1 has a wrong label.

The example in FIG. 5 shows that for the identification data D1, the result of identification is “OK” and the label is “NG”. In the example in FIG. 5, distances of three pieces of similar data D21 are 0 (zero), 1.82, and 1.95 from the left as in the example shown in FIG. 4. However, in the example shown in FIG. 5, all of the labels of the three pieces of similar data D21 are “OK” unlike those shown in FIG. 4.

Also in the present variation, the decider 16 identifies a piece of particular learning data D22 similar to the identification data D1 to such an extent that the index relating to the similarity satisfies a predetermined condition (here, the distance is shorter than or equal to a predetermined distance (threshold)) from the one or more pieces of similar data D21 (learning data D2). Here, when a label of the piece of particular learning data D22 is inconsistent with the label of the identification data D1 and a label of a piece of learning data D23 of the one or more pieces of similar data D21 except for the particular learning data D22 is consistent with the label of the piece of particular learning data D22, the decider 16 makes a decision that the identification data D1 is more likely to have a wrong label than the piece of particular learning data D22.

In the example shown in FIG. 5, the “distance” of a piece of similar data D21 at the left end of the three pieces of similar data D21 is shorter than or equal to a predetermined distance (0.001), and therefore, the decider 16 determines that the piece of similar data D21 at the left end corresponds to the piece of particular learning data D22 which is very similar to the identification data D1. The label (OK) of the piece of particular learning data D22 is inconsistent with the label (NG) of the identification data D1, and the labels (OK) of the two pieces of learning data D23 except for the piece of particular learning data D22 are consistent with the label (OK) of the piece of particular learning data D22. The decider 16 thus makes a decision that the identification data D1 is more likely to have a wrong label than the piece of particular learning data D22.

Here, when the number of pieces of learning data D23 which are consistent with the label of the piece of particular learning data D22 is larger than the number of pieces of learning data D23 which are inconsistent with the label of the piece of particular learning data D22, the decider 16 makes a decision that the identification data D1 is likely to have a wrong label. In the example shown in FIG. 5, the number of pieces of learning data D23 which are consistent with the label of the piece of particular learning data D22 is two and is large than the number of (zero) pieces of learning data D23 which are inconsistent with the label of the piece of particular learning data D22, and therefore, a decision that the identification data D1 is likely to have a wrong label is made.

In the present operation example, the identification data D1, for which the decision has been made that it is likely to have the wrong label, is presented in such a manner that character data “Wrong label” is superposed on an image of the identification data D1 and the image is surrounded by a frame as shown in FIG. 5. Moreover, information on the label and the result of the identification of the identification data D1 and information on the labels and information on the distance of each piece of similar data D21 are also shown together with the image. Thus, the user can easily understand that the “NG” label assigned to the identification data D1 is incorrect and a correct label should be “OK” by checking the information presented by the presentation device 17.

When the number of pieces of learning data D23 which are consistent with the label of the piece of particular learning data D22 is smaller than or equal to the number of pieces of learning data D23 which are inconsistent with the label of the piece of particular learning data D22, the decider 16 makes a decision that a wrong label is absent. The processor 10 causes the presentation device 17 to present an image of the identification data D1 and images of the three pieces of similar data D21 together with a massage saying, for example, “Please check visually”. In other words, when the decision thus made is that no wrong label is present, the presentation device 17 presents both the identification data D1 and the one or more pieces of similar data D21 (learning data D2). That is, the processing system 1 prompts a user to have a check visually when automatically making a decision as to the presence or absence of a wrong label by the processing system 1 is difficult.

<Fifth Operation Example: There Are Similar Data Having “OK” Label and Similar Data Having “NG” Label>

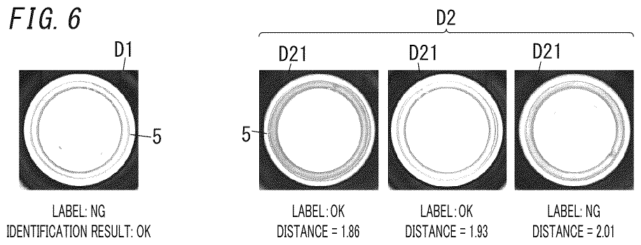

The fifth operation example will be described below with reference to FIG. 6. The detailed description of operation substantially common with the first operation example described above may be omitted.

In FIG. 2B referenced along with the description of the first and second operation examples, all the labels of the three pieces of similar data D21 thus extracted are “OK”. The present operation example (fifth operation example) will be described with reference to FIG. 6 showing an example in which labels of three pieces of similar data D21 extracted, as in FIG. 4 referenced along with the description of the third operation example, include “OK” labels and an “NG” label. However, unlike FIG. 4 referenced along with the description of the third operation example, no piece of similar data D21 whose distance is shorter than or equal to a predetermined distance (0.001) and which is very similar to the identification data D1 is found in FIG. 6.

The processor 10 of the processing system 1 acquires a plurality of pieces of labeled learning data D2, a learned model M1, and labeled identification data D1 (FIG. 3: S1 to S3). In the present operation example, the identification data D1 is assigned an “NG” label (see FIG. 6).

The processor 10 then identifies the identification data D1 by using the learned model M1 (FIG. 3: S4). Here, a result of the identification is supposed to be “OK” (see FIG. 6). The processor 10 compares the result of the identification with the label of the identification data D1 (FIG. 3: S5). In the present operation example, the result of the identification is “OK” and the label is “NG”, and therefore, the process proceeds to the extraction process and the decision process.

The processor 10 extracts a plurality of pieces of similar data D21 from the plurality of pieces of learning data D2 (FIG. 3: S7). In this example, the distances of the three pieces of similar data D21 are 1.86, 1.93, and 2.01 from the left. Moreover, in this example, the labels of the three pieces of similar data D21 are “OK”, “OK”, and “NG” from the left. In sum, the three pieces of similar data D21 shown in FIG. 6 include both pieces of similar data having OK labels and a piece of similar data having an NG label although the distances of the three pieces of similar data to the identification data D1 are substantially equal to each other.

The processor 10 then makes, based on the identification data D1 and the three pieces of similar data D21, the decision as to the presence or absence of a wrong label (FIG. 3: S8).

In the present operation example, for example, the decider 16 is configured to make the decision as to the presence or absence of a wrong label on the basis of the inconsistency ratio (degree of mislabeling) between the label of the identification data D1 and each of the labels of the three pieces of similar data D21 in a similar manner to the first operation example. In the example shown in FIG. 6, the labels of two of the three pieces of similar data D21 are inconsistent with the “NG” label of the identification data D1. As a result, the inconsistency ratio (degree of mislabeling) is about 67%. Thus, in the present operation example, the degree of mislabeling is lower than the threshold (e.g., 90%), and the decider 16 thus makes a decision that a wrong label is absent.

In this case, the processor 10 causes the presentation device 17 to present the image of the identification data D1 and images of the three pieces of similar data D21 together with a message, saying, for example, “Similar data include OK images and an NG image. Please check visually”. In other words, when the decision thus made is that no wrong label is present, the presentation device 17 presents both the identification data D1 and the one or more pieces of similar data D21 (learning data D2). That is, similarly to the third operation example, the processing system 1 prompts a user to have a check visually when automatically making a decision as to the presence or absence of a wrong label by the processing system 1 is difficult.

<Advantages>

To generate a model by machine learning, training data (identification data D1 and learning data D2) have to be labeled by a person. However, when labels are assigned by a person, simple work mistakes may occur, or the standard of labeling may become vague depending on people. In particular, depending on the type of the object 5, an image which should be assigned an OK label and an image which should be assigned an NG label may appear to be similar images to a person who are less skilled. As a result, the labeled training data may include data assigned a wrong label. For example, an image which should be assigned an OK label may be assigned an NG label as a wrong label, or an image which should be assigned an NG label may be assigned an OK label as a wrong label. A wrong label may be present in identification data D1 which is newly obtained as well as in a great many pieces of learning data D2 used for generation of the learned model Ml.

As explained in connection with the first to fifth operation examples, the processing system 1 according to the present embodiment (automatically) extracts one or more pieces of similar data D21 similar to the identification data D1. The user easily identifies the presence or absence of a wrong label by visually checking at least once the identification data D1 and the one or more pieces of similar data D21 through the presentation device 17. Thus, the processing system 1 can assist the user with work relating to identification of a wrong label. Consequently, time required to identify a wrong label can be reduced. Moreover, learning is performed based on the training data from which a wrong label has been removed, and therefore, the accuracy of the estimation phase based on the learned model M1 is also improved.

The processing system 1 has a function of automatically detecting a wrong label, that is, includes the decider 16 configured to make the decision as to the presence or absence of a wrong label. The decider 16 is, however, not an essential configuration element of the processing system 1. Note that as in the present embodiment, providing the decider 16 enables time required to identify a wrong label to be further reduced.

Moreover, the processing system 1 includes the presentation device 17 configured to present the information (presentation information D4) on the decision made by the decider 16 to an outside, thereby facilitating a visual check by the user.

In addition, when the decision made by the decider 16 is that a wrong label is present, the presentation device 17 presents information indicating which of the identification data D1 and the similar data D21 has the wrong label. Thus, the user can easily visually check which data has the wrong label.

In particular, when the decision thus made is that no wrong label is present, the presentation device 17 presents both the identification data D1 and the similar data D21. This facilitates a visual check of both the identification data D1 and the similar data D21 by a user, and consequently, the user can easily find the wrong label if the wrong label is actually present in the identification data D1 or the similar data D21. Moreover, when another failure (e.g., underfitting or overfitting) other than the wrong label is included, the another failure is also easily found.

For example, the user checks the presentation device 17, and if top several pieces of similar data D21 having the higher similarity (shorter distance) are not very similar to the identification data D1, the user can make a decision that the learned model M1 is high possibility underfitting.

Note that the processor 10 of the processing system 1 may automatically make a decision regarding the underfitting of the learned model M1 on the basis of the distances of the top several pieces of similar data D21 thus extracted. In FIG. 3, for example, after the extraction process (S7), the distance of each piece of similar data D21 thus extracted is checked, and if the distance is greater than or equal to a certain value, a decision that the learned model M1 is underfitting is made, and the process does not proceed to the next decision process (S8), but the presentation device 17 presents a message saying “Underfitting”, and the process may be ended.

(3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Also, the functions of the processing system 1 according to the exemplary embodiment described above may also be implemented as, for example, a processing method, a computer program, or a non-transitory storage medium on which the computer program is stored.

Next, variations of the exemplary embodiment will be enumerated one after another. Note that the variations to be described below may be adopted in combination as appropriate. In the following description, the exemplary embodiment described above will be hereinafter sometimes referred to as a “basic example.”

The processing system 1 according to the present disclosure includes a computer system. The computer system may include a processor and a memory as principal hardware components. The functions of the processing system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the processing system 1 are aggregated together in a single housing. However, this is not an essential configuration. Alternatively, those constituent elements of the processing system 1 may be distributed in multiple different housings.

Conversely, the plurality of functions of the processing system 1 may be aggregated together in a single housing. Still alternatively, at least some functions of the processing system 1 (e.g., some functions of the processing system 1) may be implemented as a cloud computing system as well.

In the basic example, the identification data D1 is newly obtained training data for re-learning. However, the identification data D1 may be the learning data D2 used to generate the learned model M1. For example, after the learned model M1 is generated, the accuracy of the learned model M1 may not be 100%. In such a case, in order to check and/or evaluate the accuracy of the learned model Ml, some or all of the pieces of learning data D2 used to generate the learned model M1 may be input, as identification data D1, to the processing system 1.

The identification data D1 may be one of a plurality of pieces of training data prepared for machine learning of a model. That is, the plurality of pieces of training data prepared for learning of a model are divided into a plurality of pieces of learning data D2 and the identification data D1. In this case, the processing system 1 can divide the plurality of pieces of training data to perform cross-validation of evaluating the learned model M1 and determine the presence or absence of a wrong label in a label assigned to the identification data D1 and a label assigned to each of the plurality of pieces of learning data D2.

Alternatively, the processing system 1 may divide the plurality of pieces of training data into the learning data D2 and the identification data D1 a plurality of number of times, perform k-fold cross-validation, and additionally determine the presence or absence of a wrong label in a label assigned to the identification data D1 and a label assigned to each of the plurality of pieces of learning data D2.

In the basic example, also when a decision that that the identification data D1 (or similar data D21) has a wrong label is made, the presentation device 17 presents both the identification data D1 and the similar data D21. However, the presentation device 17 may present only the data, for which the decision has been made that it has the wrong label.

The image capture device 4 is not limited to the line sensor camera but may be an area sensor camera.

In the basic example, the training data (identification data D1 and learning data D2) is image data to which a label has been assigned. However, the training data is not limited to the image data but may be text data or voice data to which a label has been assigned. That is, the application of the learned model M1 is not limited to identification of images (image recognition), but the learned model M1 may be applied to, for example, identification of text (text recognition) or identification of voice (voice recognition).

In the basic example, the learned model M1 generated by the learning system 2 is a model generated by deep learning. However, the learned model M1 is not limited to a model generated by the deep learning. The learned model M1 may be implemented as any type of artificial intelligence or system.

In the basic example, the algorithm of the machine learning is neural network (including deep learning). However, the algorithm of the machine learning is not limited to the neural network but may be an algorithm of any other supervised learning. The algorithm of the machine learning may be, for example, Linear Regression, Logistic Regression, Support Vector Machine (SVM), Decision Tree, Random Forest, Gradient Boosting, Naive Bayes classifier, or k-Nearest Neighbors (k-NN).

(4) Recapitulation

As described above, a processing system (1) of a first aspect includes a first acquirer (11), a second acquirer(12), a third acquirer (13), an identifier (14), and an extractor (15). The first acquirer (11) is configured to acquire a plurality of pieces of learning data (D2) to which labels have been assigned. The second acquirer(12) is configured to acquire a learned model (M1) generated based on the plurality of pieces of learning data (D2). The third acquirer (13) is configured to acquire identification data (D1) to which a label has been assigned. The identifier (14) is configured to identify the identification data (D1) on a basis of the learned model (M1). The extractor (15) is configured to extract, based on an index which relates to similarity between the identification data (D1) and each of the plurality of pieces of learning data (D2), one or more pieces of learning data (similar data D21) similar to the identification data (D1) from the plurality of pieces of learning data (D2). The index is an index applied in the learned model (M1).

With this aspect, the one or more pieces of learning data (D2) similar to the identification data (D1) are extracted. Therefore, the presence or absence of a wrong label can be identified by simply checking (e.g., once) the identification data (D1) and the one or more pieces of learning data (similar data D21) similar to the identification data (D1). Consequently, time required to identify a wrong label can be reduced.

A processing system (1) of a second aspect referring to the first aspect, further includes a decider (16) configured to make a decision as to presence or absence of a wrong label on a basis of the identification data (D1) and the one or more pieces of learning data (similar data D21).

With this aspect, the presence or absence of a wrong label is automatically determined, which enables time required to identify a wrong label to be further reduced.

A processing system (1) of a third aspect referring to the second aspect further includes a presentation device (17) configured to present information on the decision made by the decider (16) to an outside.

With this aspect, the information on the decision made by the decider (16) is easily visually checked by a user.

In a processing system (1) of a fourth aspect referring to the third aspect, the presentation device (17) is configured to, when the decision is that the wrong label is present, present information indicating which of the identification data (D1) and the one or more pieces of learning data (similar data D21) has the wrong label.

With this aspect, which of the identification data (D1) and the one or more pieces of learning data (similar data D21) has the wrong label can be easily visually checked.

In a processing system (1) of a fifth aspect referring to the third or fourth aspect, the presentation device (17) is configured to, when the decision is that the wrong label is absent, present both the identification data (D1) and the one or more pieces of learning data (similar data D21).

This aspect facilitates a visual check of both the identification data (D1) and the one or more pieces of learning data (similar data D21) by a user, and consequently, the user can easily find the wrong label if the wrong label is actually present in the identification data (D1) or the one or more pieces of learning data. Moreover, also when a failure other than the wrong label is included, the failure can be easily found.

A processing system (1) of a sixth aspect referring to any one of the second to fifth aspects, the decider (16) is configured to, when a result of identification of the identification data (D1) by the identifier (14) is inconsistent with the label assigned to the identification data (D1), make the decision as to the presence or absence of the wrong label.

With this aspect, a reduction in processing load is attempted. This also enables time required to identify a wrong label to be further reduced.

In a processing system (1) of a seventh aspect referring to any one of the second to sixth aspects, the decider (16) is configured to make the decision as to the presence or absence of the wrong label on a basis of at least one of: the label assigned to the identification data (D1) and one or more labels respectively assigned to the one or more pieces of learning data (similar data D21); or the index relating to the similarity between the identification data (D1) and each of the one or more pieces of learning data (similar data D21).

With this aspect, the reliability relating to determination of the wrong label is improved.

In a processing system (1) of an eighth aspect referring to the seventh aspect, the decider (16) is configured to make the decision as to the presence or absence of the wrong label on a basis of an inconsistency ratio between the label assigned to the identification data (D1) and each of the one or more labels respectively assigned to the one or more pieces of learning data (similar data D21).

With this aspect, the reliability relating to determination of the wrong label is easily improved.

In a processing system (1) of a ninth aspect referring to the seventh aspect, the decider (16) is configured to make the decision as to the presence or absence of the wrong label on a basis of both of: the label assigned to the identification data (D1) and the one or more labels respectively assigned to the one or more pieces of learning data (similar data D21); and the index relating to the similarity of each of the one or more pieces of learning data (similar data D21).

With this aspect, the reliability relating to a decision regarding the wrong label is further improved.

In a processing system (1) of a tenth aspect referring to the ninth aspect, the extractor (15) is configured to extract two or more pieces of learning data (similar data D21) as the one or more pieces of learning data (similar data D21) from the plurality of pieces of learning data (D2). The decider (16) is configured to identify a piece of particular learning data (D22) similar to the identification data (D1) to such an extent that the index relating to the similarity satisfies a predetermined condition from the two or more pieces of learning data (similar data D21). The decider (16) is configured to, when the label assigned to the piece of particular learning data (D22) is inconsistent with the label assigned to the identification data (D1) and the label assigned to a piece of learning data (D23) of the two or more pieces of learning data (similar data D21) except for the piece of particular learning data (D22) is consistent with the label assigned to the identification data (D1), make a decision that the piece of particular learning data (D22) is more likely to have the wrong label than the identification data (D1).

With this aspect, the reliability relating to determination of the wrong label is further improved.

In a processing system (1) of an eleventh aspect referring to the ninth aspect, the extractor (15) is configured to extract two or more pieces of learning data (similar data D21) as the one or more pieces of learning data (similar data D21) from the plurality of pieces of learning data (D2). The decider (16) is configured to identify a piece of particular learning data (D22) similar to the identification data (D1) to such an extent that the index relating to the similarity satisfies a predetermined condition from the two or more pieces of learning data (similar data D21). The decider (16) is configured to, when the label assigned to the piece of particular learning data (D22) is inconsistent with the label assigned to the identification data (D1) and the label assigned to a piece of learning data (D23) of the two or more pieces of learning data (similar data D21) except for the piece of particular learning data (D22) is consistent with the label assigned to the piece of particular learning data (D22), make a decision that the identification data (D1) is more likely to have the wrong label than the piece of particular learning data (D22).

With this aspect, the reliability relating to a decision regarding the wrong label is further improved.

In a processing system (1) of a twelfth aspect referring to any one of the first to eleventh aspects, the learned model (M1) is a model generated based on the plurality of pieces of learning data (D2) by applying deep learning.

With this aspect, the reliability of the learned model (M1) and reliability relating to a decision regarding the wrong label are further improved.

A learning processing system (100) of a thirteenth aspect includes the processing system (1) of any one of the first to twelfth aspects and a learning system (2) configured to generate the learned model (M1).

This aspect provides a learning processing system (100) configured to reduce time required to identify the wrong label.

A processing method of a fourteenth aspect includes a first acquisition step, a second acquisition step, a third acquisition step, an identification step, and an extraction step. The first acquisition step includes acquiring a plurality of pieces of learning data (D2) to which labels have been assigned. The second acquisition step includes acquiring a learned model (M1) generated based on the plurality of pieces of learning data (D2). The third acquisition step acquires identification data (D1) to which a label has been assigned. The identification step includes identifying the identification data (D1) on a basis of the learned model (M1). The extraction step includes extracting, based on an index which is applied in the learned model (M1) and which relates to similarity between the identification data (D1) and each of the plurality of pieces of learning data (D2), one or more pieces of learning data (similar data D21) similar to the identification data (D1) from the plurality of pieces of learning data (D2).

This aspect provides a processing method configured to reduce time required to identify the wrong label.

A program of a fifteenth aspect is a program configured to cause one or more processors to execute the processing method of the fourteenth aspect.

This aspect provides a function of reducing time required to identify the wrong label.

A processing system (1) of a sixteenth aspect referring to any one of the first to twelfth aspects, the extractor (15) is configured to, when a result of identification of the identification data (D1) by the identifier (14) is inconsistent with the label assigned to the identification data (D1), extract one or more pieces of learning data (similar data D21) from the plurality of pieces of learning data (D2).

Note that the constituent elements according to the second to twelfth aspects are not essential constituent elements for the processing system (1) but may be omitted as appropriate. Likewise, the constituent elements according to the sixteenth aspect are not essential constituent elements for the processing system (1) but may be omitted as appropriate.

### REFERENCE SIGNS LIST

100 Learning Processing System
1 Processing System
11 First Acquirer
12 Second Acquirer
13 Third Acquirer
14 Identifier
15 Extractor
16 Decider
17 Presentation Device
2 Learning System
D1 Identification Data
D2 Learning Data
D21 One or More Pieces of Similar Data (One or More Pieces of Learning Data)
D22 Particular Learning Data
M1 Learned Model

1. A processing system, comprising:
a first acquirer configured to acquire a plurality of pieces of learning data to which labels have been assigned;
a second acquirer configured to acquire a learned model generated based on the plurality of pieces of learning data;
a third acquirer configured to acquire identification data to which a label has been assigned;
an identifier configured to identify the identification data on a basis of the learned model; and
an extractor configured to extract, based on an index which is applied in the learned model and which relates to similarity between the identification data and each of the plurality of pieces of learning data, one or more pieces of learning data similar to the identification data from the plurality of pieces of learning data.

2. The processing system of claim 1, further comprising a decider configured to make a decision as to presence or absence of a wrong label on a basis of the identification data and the one or more pieces of learning data.

3. The processing system of claim 2, further comprising a presentation device configured to present information on the decision made by the decider to an outside.

4. The processing system of claim 3, wherein
the presentation device is configured to, when the decision is that the wrong label is present, present information indicating which of the identification data and the one or more pieces of learning data has the wrong label.

5. The processing system of claim 3, wherein
the presentation device is configured to, when the decision is that the wrong label is absent, present both the identification data and the one or more pieces of learning data.

6. The processing system of claim 2, wherein
the decider is configured to, when a result of identification of the identification data by the identifier is inconsistent with the label assigned to the identification data, make the decision as to the presence or absence of the wrong label.

7. The processing system of claim 2, wherein
the decider is configured to make the decision as to the presence or absence of the wrong label on a basis of at least one of:
the label assigned to the identification data and one or more labels respectively assigned to the one or more pieces of learning data; or
the index relating to the similarity between the identification data and each of the one or more pieces of learning data.

8. The processing system of claim 7, wherein
the decider is configured to make the decision as to the presence or absence of the wrong label on a basis of an inconsistency ratio between the label assigned to the identification data and each of the one or more labels respectively assigned to the one or more pieces of learning data.

9. The processing system of claim 7, wherein
the decider is configured to make the decision as to the presence or absence of the wrong label on a basis of both of:
the label assigned to the identification data and the one or more labels respectively assigned to the one or more pieces of learning data; and
the index relating to the similarity of each of the one or more pieces of learning data.

10. The processing system of claim 9, wherein
the extractor is configured to extract two or more pieces of learning data as the one or more pieces of learning data from the plurality of pieces of learning data,
the decider is configured to identify a piece of particular learning data similar to the identification data to such an extent that the index relating to the similarity satisfies a predetermined condition from the two or more pieces of learning data, and
the decider is configured to, when the label assigned to the piece of particular learning data is inconsistent with the label assigned to the identification data and the label assigned to a piece of learning data of the two or more pieces of learning data except for the piece of particular learning data is consistent with the label assigned to the identification data, make a decision that the piece of particular learning data is more likely to have the wrong label than the identification data.

11. The processing system of claim 9, wherein
the extractor is configured to extract two or more pieces of learning data as the one or more pieces of learning data from the plurality of pieces of learning data,
the decider is configured to identify a piece of particular learning data similar to the identification data to such an extent that the index relating to the similarity satisfies a predetermined condition from the two or more pieces of learning data, and
the decider is configured to, when the label assigned to the piece of particular learning data is inconsistent with the label assigned to the identification data and the label assigned to a piece of learning data of the two or more pieces of learning data except for the piece of particular learning data is consistent with the label assigned to the piece of particular learning data, make a decision that the identification data is more likely to have the wrong label than the piece of particular learning data.

12. The processing system of claim 1, wherein
the learned model is a model generated based on the plurality of pieces of learning data by applying deep learning.

13. A learning processing system comprising:
the processing system of claim 1; and
a learning system configured to generate the learned model.

14. A processing method comprising:
a first acquisition step of acquiring a plurality of pieces of learning data to which labels have been assigned;
a second acquisition step of acquiring a learned model generated based on the plurality of pieces of learning data;
a third acquisition step of acquiring identification data to which a label has been assigned;
an identification step of identifying the identification data on a basis of the learned model; and
an extraction step of extracting, based on an index which is applied in the learned model and which relates to similarity between the identification data and each of the plurality of pieces of learning data, one or more pieces of learning data similar to the identification data from the plurality of pieces of learning data.

15. A non-transitory computer-readable tangible recording medium storing a program configured to cause one or more processors to execute the processing method of claim 14.
